(19) United States
(12) Patent Application Publication
(10) Pub. No.: US 2026/0254183 A1
(43) Pub. Date: Aug. 27, 2026

(54) ROTARY CONNECTOR

(71) Applicant: EAGLE INDUSTRY CO., LTD., Tokyo (JP)

(72) Inventors: Yasunari FURUKAWA, Tokyo (JP); Hayata ETO, Tokyo (JP); Mamoru HAYATA, Tokyo (JP); Masashi KAMITANI, Tokyo (JP); Hiroshi SAWADA, Tokyo (JP)

(21) Appl. No.: 19/159,200

(22) PCT Filed: Mar. 1, 2024
(86) PCT No.: PCT/JP2024/007731

§ 371 Date: Aug. 22, 2025

(30) Foreign Application Priority Data
Mar. 15, 2023 (JP) 2023-040535

(51) Int. Cl. H01R 39/64; H01R 39/08; H01R 39/28

(52) U.S. Cl. CPC H01R 39/643; H01R 39/08; H01R 39/28

(57) ABSTRACT

An object of the present invention is to provide a rotary connector having a plurality of channels. A rotary connector (1) of the present invention includes an annular outer peripheral electrode (5), an inner peripheral electrode (4) inserted into the outer peripheral electrode (5) and arranged so as to be turnable relatively to the outer peripheral electrode (5), annular roller current collectors (60) arranged between the outer peripheral electrode (5) and the inner peripheral electrode (4), the roller current collectors being in contact with the outer peripheral electrode (5) and the inner peripheral electrode (4), retainer pins (61) inserted into the roller current collectors (60) and holding the roller current collectors (60), and a retainer plate (7B) that axially supports the retainer pins (61), wherein the retainer pins (61) are respectively axially supported on the axially one side and on the axially other side of the retainer plate (7B), and the retainer pin (61) axially supported on the axially one side and the retainer pin (61) axially supported on the axially other side are arranged in different phases.

### TECHNICAL FIELD

The present invention relates to a rotary connector, for example, a rotary connector having a plurality of channels.

### BACKGROUND ART

In a rotary connector utilized for electrically connecting a turning side element and a stationary side element in a turning mechanism in various industrial fields, it is possible to electrically connect a conductive inner peripheral electrode to be coupled to the turning side element and a conductive outer peripheral electrode to be electrically connected to the stationary side element through a current collector element arranged between the inner peripheral electrode and the outer peripheral electrode.

As such a rotary connector, a rotary connector in which liquid metal of mercury, gallium alloy, etc., is charged as a current collector element, and a rotary connector in which a plurality of roller current collectors having a power distribution property are arranged are known. In recent years, from a viewpoint of an environmental load due to liquid leakage, an electrical leakage risk, etc., the rotary connector in which the roller current collectors are applied has attracted attention.

For example, in a rotary connector shown in Patent Citation 1, a plurality of power distribution rings are arranged between a rotating shaft and a body. A gap between the power distribution rings is held by a plurality of retainer pins and a pair of retainer plates. In the retainer plate, a plurality of through holes passing through in the axial direction are arranged at equal intervals. The retainer pins are inserted into the corresponding through holes in the retainer plates, and held so as to be turnable relatively to the retainer plates. The power distribution rings are inserted and held onto the retainer plates.

In the rotary connector configured in such a way, the power distribution rings are driven by rotation of the rotating shaft and rotated integrally with the retainer pins and relatively to the retainer plates, that is, spin on their own axes. Also, the power distribution rings orbit by turning of the retainer plates driven by the rotation of the rotating shaft, and do so-called planetary motion. By these, with the rotary connector as in Patent Citation 1, it is possible to electrically connect the rotating shaft and the body while maintaining the rotation of the rotating shaft.

### CITATION LIST

### Patent Literature

### Patent Citation 1: JP 2021-170521A (Page 2, 3, FIG. 1)

### SUMMARY OF INVENTION

### Technical Problem

With the rotary connector as in Patent Citation 1, it is possible to not only electrically connect the rotating shaft and the body while maintaining the rotation of the rotating shaft as described above, but also appropriately adjust power distribution capacity by arranging the power distribution rings of the number corresponding to the power distribution capacity around the rotating shaft. A rotary connector having a plurality of channels that include such excellent characteristics has already been demanded.

The present invention has been achieved focusing on such a problem, and an object of the present invention is to provide a rotary connector having a plurality of channels.

### Solution to Problem

In order to solve the foregoing problem, a rotary connector according to the present invention is a rotary connector, including: an annular outer peripheral electrode; an inner peripheral electrode inserted into the outer peripheral electrode and arranged so as to be turnable relatively to the outer peripheral electrode; annular roller current collectors arranged between the outer peripheral electrode and the inner peripheral electrode, the roller current collectors being in contact with the outer peripheral electrode and the inner peripheral electrode; retainer pins inserted into the roller current collectors and holding the roller current collectors; and a retainer plate that axially supports the retainer pins, wherein the retainer pins are respectively axially supported on an axially one side and on an axially other side of the retainer plate, and wherein the retainer pin axially supported on the axially one side and the retainer pin axially supported on the axially other side are arranged in different phases. According to the feature of the present invention, in the rotary connector, the retainer pins at respective stages are prevented from interfering with each other. Therefore, it is possible to provide a plurality of channels, and make power distribution capacity in the channels variable. Further, with the rotary connector, it is possible to shorten an axial size.

It may be preferable that the retainer pins are arranged at equal intervals in the circumferential direction. According to this preferable configuration, with the rotary connector, it is possible to prevent an adverse effect by uneven distribution of a centrifugal force, etc., generated in the retainer pins at the time of rotation. Therefore, with the rotary connector, it is possible to stably maintain a power distribution state.

It may be preferable that a plurality of through holes are formed in the retainer plate. According to this preferable configuration, with the rotary connector, the number of the retainer pins and the roller current collectors is simply and conveniently adjusted in accordance with required power distribution capacity. Also, with the rotary connector, it is possible to shorten the axial size with a simple and convenient structure.

It may be preferable that the plurality of through holes are formed on a single circumference. According to this preferable configuration, it is possible to configure the rotary connector to have a small diameter.

It may be preferable that in the retainer plate, a plurality of recess portions are respectively formed on a surface on the axially one side and on a surface on the axially other side. According to this preferable configuration, with the rotary connector, the number of the retainer pins and the roller current collectors is simply and conveniently adjusted in accordance with the required power distribution capacity. Also, with the rotary connector, it is possible to shorten the axial size with a simple and convenient structure.

It may be preferable that the plurality of recess portions are formed on a single circumference. According to this preferable configuration, it is possible to configure the rotary connector to have a small diameter.

It may be preferable that the retainer pin axially supported on the axially one side and the retainer pin axially supported on the axially other side are also axially supported by other retainer plates respectively arranged on the axially opposite sides of the retainer plate. According to this preferable configuration, with the rotary connector, it is possible to make one set with a double layer structure configured by the two groups of retainer pins at adjacent stages, the retainer plate in the middle, and the two other retainer plates. Therefore, with the rotary connector, it is possible to simply and conveniently configure a stable structure.

It may be preferable that the rotary connector is vertically placed, a lower end side of the retainer pin axially supported on the axially other side is axially supported by a retainer plate on the lower end side, the retainer plate being other than the retainer plate, and the retainer plate on the lower end side is disposed on an extension portion on the lower end side, the extension portion extending from one side of an outer peripheral electrode side and an inner peripheral electrode side to other side.

According to this preferable configuration, with the rotary connector, it is possible to reliably support the plurality of retainer plates, the roller current collectors, and the retainer pins which are stacked, and stabilize a power distribution effect. Also, with the rotary connector, it is possible to trap abrasion powder at the extension portion.

It may be preferable that an upper end side of the retainer pin axially supported on the one side is axially supported by a retainer plate on the upper end side, the retainer plate being other than the retainer plate, and the retainer plate on the upper end side is arranged on the lower side of an extension portion on the upper end side, the extension portion extending from one side of the outer peripheral electrode side and the inner peripheral electrode side to other side. According to this preferable configuration, the other retainer plates arranged in both axial ends are arranged between the extension portions arranged in both the axial ends. Therefore, with the rotary connector, it is possible to regulate the plurality of retainer plates, the roller current collectors, and the retainer pins which are stacked from inclining and moving in the axial direction, and suppress generation of breakdown.

### BRIEF DESCRIPTION OF DRAWINGS

FIG. 1 is a perspective view of a rotary connector according to a first embodiment of the present invention.

FIG. 2 is a cross-sectional view of the rotary connector according to the first embodiment of the present invention.

FIG. 3A is a cross-sectional view by the line A-A in FIG. 2, and FIG. 3B is a cross-sectional view by the line B-B in FIG. 2.

FIG. 4 is a cross-sectional view by the line C-C in FIG. 3.

FIG. 5 is a cross-sectional view of a rotary connector according to a second embodiment of the present invention.

FIG. 6A is a cross-sectional view by the line D-D in FIG. 5, and FIG. 6B is a cross-sectional view by the line E-E in FIG. 5.

FIG. 7 is a cross-sectional view by the line F-F in FIG. 6.

FIG. 8 is a cross-sectional view of a rotary connector according to a third embodiment of the present invention.

### DESCRIPTION OF EMBODIMENTS

Modes for implementing a rotary connector according to the present invention will be described based on embodiments.

### First Embodiment

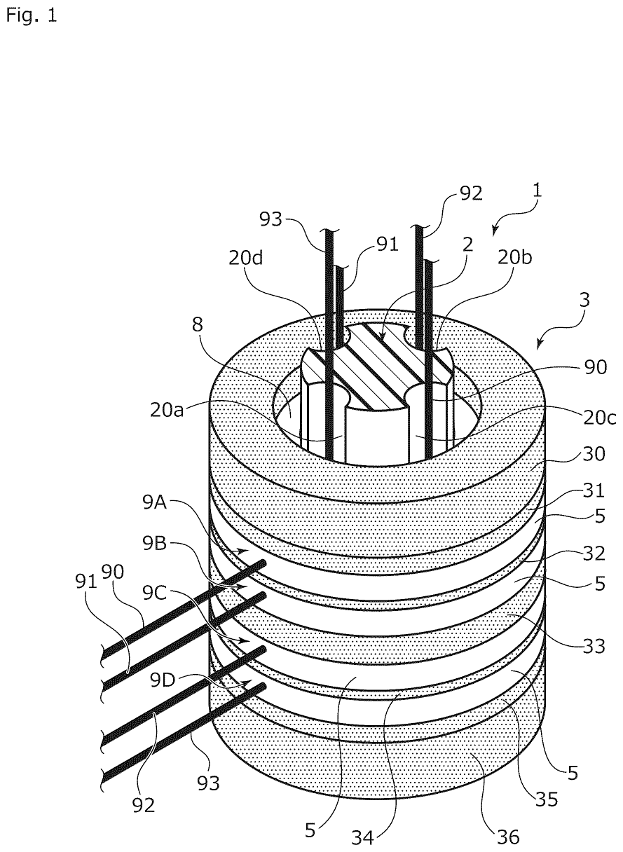

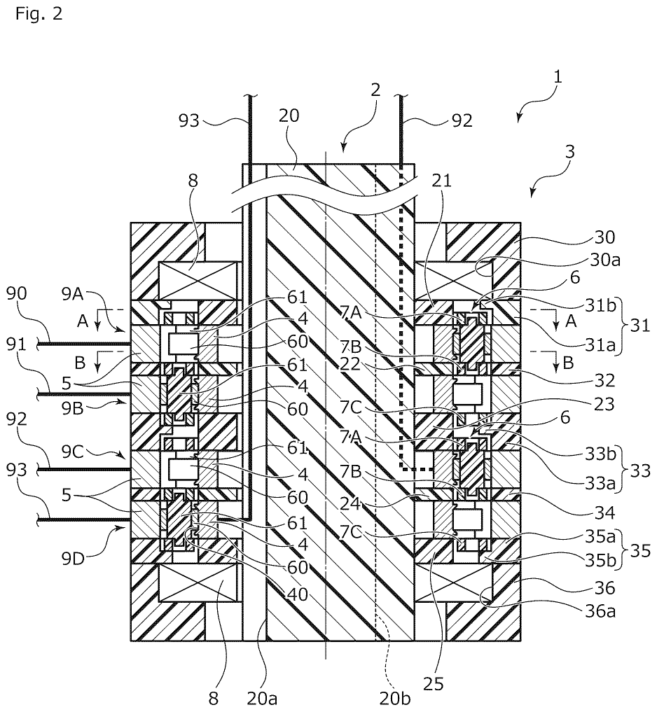

Next, a rotary connector according to a first embodiment of the present invention will be described with reference to FIGS. 1 to 4. Hereinafter, a description will be given with the upper and lower sides seen from the front side of FIG. 2 serving as the upper and lower sides of the rotary connector.

A rotary connector 1 according to the first embodiment of the present embodiment is applied to a semiconductor manufacturing machine serving as a rotating device, for example, and used for power distribution of a temperature adjusting device that heats a substrate of a semiconductor, or power distribution of a thermocouple that measures a temperature of the substrate to be heated.

As illustrated in FIGS. 1 and 2, the rotary connector 1 is mainly configured by a rotating body 2, a stationary body 3, two sets of connecting bodies 6, and two bearings 8 (see FIG. 2), and includes four channels 9A, 9B, 9C, 9D for individually distributing power through four conducting wires 90 to 93 respectively connected to the rotating body 2 side and the stationary body 3 side. This rotary connector 1 is used to be placed vertically.

The rotating body 2 is mainly configured by a rotating shaft 20, five spacers 21 to 25, and four inner peripheral electrodes 4.

The rotating shaft 20 is made of an insulator and formed in a columnar shape. The rotating shaft 20 is fitted into and axially supported by the two bearings 8 fitted in and fixed to an upper end portion and a lower end portion in the stationary body 3. It is noted that a shape of the rotating shaft 20 may be appropriately changed in accordance with a purpose of use. For example, the shape may be a hollow shape, or a temperature adjusting device may be provided in a distal end.

Four through grooves 20a to 20d are formed on the radially outer side of the rotating shaft 20. The through grooves 20a to 20d are provided to be recessed to the radially inner side from an outer circumferential surface of the rotating shaft 20, to be open to the radially outer side, and to pass through in the axial direction, and are formed in a U shape when seen in the axial direction (see FIG. 1). Any one of the conducting wires 90 to 93 is inserted into each of the through grooves 20a to 20d, so that crossing of the conducting wires 90 to 93 is suppressed.

The spacer 21 positioned at the uppermost stage is made of an insulator and formed in an annular shape having a rectangular section. An inner diameter of the spacer 21 is the substantially same size as an outer diameter of the rotating shaft 20, and the spacer 21 is fitted and fixed onto the rotating shaft 20.

The spacer 22 positioned at the second stage from the top is made of an insulator and formed in an annular shape having a rectangular section. An inner diameter of the spacer 22 is the substantially same size as the inner diameter of the spacer 21, and the spacer 22 is fitted and fixed onto the rotating shaft 20.

The spacer 23 positioned at the third stage from the top and positioned in center of the spacers 21 to 25 is made of an insulator and formed in an annular shape having a rectangular section. An inner diameter of the spacer 23 is the substantially same size as the outer diameter of the rotating shaft 20, and the spacer 23 is fitted and fixed onto the rotating shaft 20.

The spacer 24 positioned at the second stage from the bottom is made of an insulator and formed in an annular shape having a rectangular section, and has the substantially same shape as the spacer 22. The spacer 24 is fitted and fixed onto the rotating shaft 20 similarly to the spacer 22.

The spacer 25 positioned at the lowermost stage is made of an insulator and formed in an annular shape having a rectangular section. An inner diameter of the spacer 25 is the substantially same size as the outer diameter of the rotating shaft 20, and the spacer 25 is fitted and fixed onto the rotating shaft 20.

Each of the inner peripheral electrodes 4 is made of metal and formed in an annular shape having a rectangular section. Each one of the inner peripheral electrodes 4 is arranged and fixed between the two adjacent spacers among the spacers 21 to 25. In other words, the spacers 21 to 25 are coupled to each other in the axial direction in a state where the inner peripheral electrodes 4 are placed between the spacers 21 to 25. Thereby, the inner peripheral electrodes 4 are rotated together with the rotating shaft 20 and the spacers 21 to 25.

Also, an inner diameter of the inner peripheral electrode 4 is slightly longer than the inner diameter of the spacer 21.

Also, on the radially outer side of the inner peripheral electrode 4, an annular groove 40 provided to be recessed toward the radially inner side and open in the radially outer direction is formed.

The stationary body 3 is mainly configured by an upper portion body 30, five spacers 31 to 35, a lower portion body 36, and four outer peripheral electrodes 5. It is noted that in FIG. 1, the upper portion body 30, the five spacers 31 to 35, and the lower portion body 36 are dotted.

As illustrated in FIG. 2, the upper portion body 30 is made of an insulator and formed in an annular shape having a downward L-shaped section. In radial center in the upper portion body 30, a recess portion 30a provided to be recessed to the axially upper side from a lower end surface and open toward the lower side is formed. The bearing 8 is fitted into the recess portion 30a. Also, in the radial center of the upper portion body 30, a through portion passing through in the up and down direction, the through portion having a hole shape is provided and continues to the recess portion 30a. A diameter size of the through portion is longer than a diameter size of the rotating shaft 20.

The spacer 31 positioned at the uppermost stage is made of an insulator and formed in an annular shape having a downward L-shaped section. The spacer 31 includes a base portion 31a and a flange portion 31b serving as an extension portion. The base portion 31a is formed in an annular shape having a rectangular section. The flange portion 31b is formed in an annular shape having a rectangular section expanding in an eave form from an axially upper end portion in the base portion 31a toward the radially inner direction. That is, the flange portion 31b is formed in an inward flange shape.

Also, an inner diameter of the base portion 31a in the spacer 31 is the substantially same size as a diameter size of the recess portion 30a in the upper portion body 30. An outer diameter of the base portion 31a is the substantially same size as an outer diameter of the upper portion body 30. An axial size of the base portion 31a is the substantially same size as an axial size of the spacer 21 in the rotating body 2. The base portion 31a is fixed to the upper portion body 30.

The spacer 32 positioned at the second stage from the top is made of an insulator and formed in an annular shape having a rectangular section. An axial size of the spacer 32 is the substantially same size as an axial size of the spacer 22 in the rotating body 2. For other portions, the spacer 32 has the substantially same shape as the base portion 31a in the spacer 31.

The spacer 33 positioned at the third stage from the top and positioned in center of the spacers 31 to 35 is made of an insulator and formed in an annular shape having a horizontally T-shaped section. The spacer 33 includes a base portion 33a and a flange portion 33b serving as an extension portion. The base portion 33a has the substantially same shape as the base portion 31a extending in the axial direction. The flange portion 33b is formed in an inward flange shape expanding from an axially central portion of the base portion 33a toward the radially inner direction.

Also, an axial size of the base portion 33a in the spacer 33 is the substantially same size as an axial size of the spacer 23 in the rotating body 2. For other portions, the spacer 33 has the substantially same shape as the base portion 31a in the spacer 31.

The spacer 34 positioned at the second stage from the bottom is made of an insulator and formed in an annular shape having a rectangular section. Also, an axial size of the spacer 34 is the substantially same size as an axial size of spacer 24 in the rotating body 2, and the spacer 34 has the substantially same shape as the spacer 32.

The spacer 35 positioned at the lowermost stage is made of an insulator and formed in an annular shape having an L-shaped section. The spacer 35 includes a base portion 35a and a flange portion 35b serving as an extension portion. The base portion 35a has the substantially same shape as the base portion 31a. The flange portion 35b is formed in an inward flange shape expanding from an axially lower end portion in the base portion 35a toward the radially inner direction.

Also, an axial size of the base portion 35a in the spacer 35 is the substantially same size as an axial size of the spacer 25 in the rotating body 2. For other portions, the spacer 35 has the substantially same shape as the base portion 31a in the spacer 31.

The lower portion body 36 is made of an insulator and formed in an annular shape having an L-shaped section. In radial center in the lower portion body 36, a recess portion 36a provided to be recessed to the axially lower side from an upper end surface and open toward the upper side is formed.

The bearing 8 is fitted into the recess portion 36a. Also, in the radial center of the lower portion body 36, a through portion passing through in the up and down direction, the through portion having a hole shape is provided and continues to the recess portion 36a. A diameter size of the through portion is longer than the diameter size of the rotating shaft 20. The lower portion body 36 is fixed to the spacer 35.

Each of the outer peripheral electrodes 5 is made of metal and formed in an annular shape having a rectangular section. An inner diameter of the outer peripheral electrode 5 is the substantially same size as an inner diameter of the spacer 31. Each one of the outer peripheral electrodes 5 is arranged and fixed between the two adjacent spacers among the spacers 31 to 35. In other words, the spacers 31 to 35 are coupled to each other in the axial direction in a state where the outer peripheral electrodes 5 are placed between the spacers 31 to 35.

Also, an outer diameter of the outer peripheral electrode 5 is the substantially same size as an outer diameter of the spacer 31. Further, an axial size of the outer peripheral electrode 5 is the substantially same size as an axial size of the inner peripheral electrode 4.

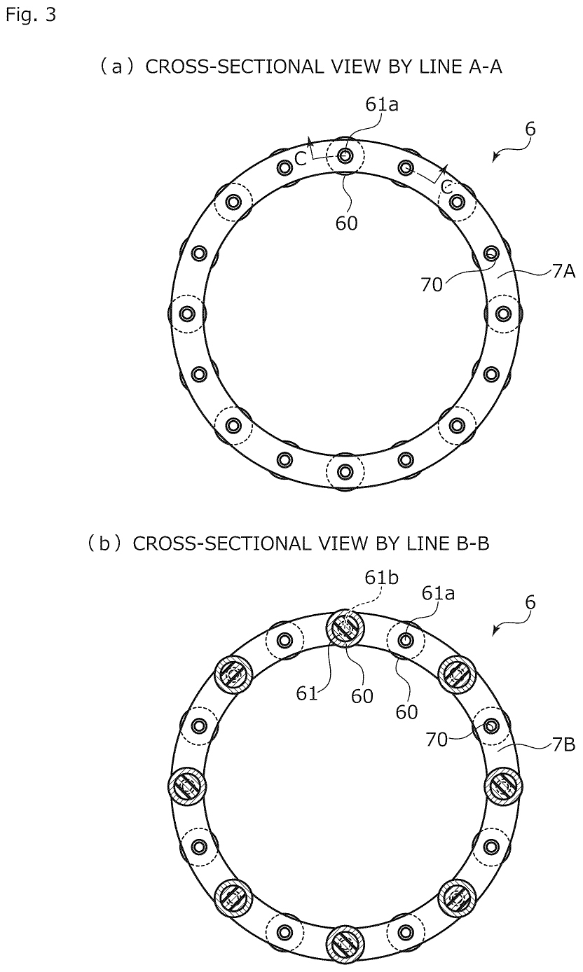

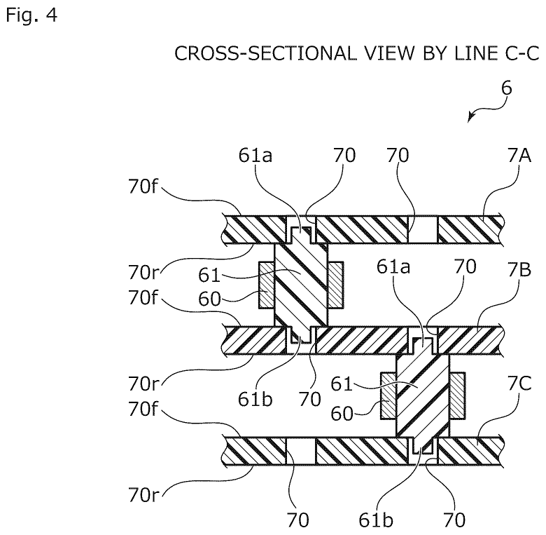

The two sets of connecting bodies 6 are arranged between the rotating body 2 and the stationary body 3 (also see FIGS. 3 and 4 for each set of connecting body 6). In more detail, one set of connecting body 6 is arranged between the flange portion 31b in the spacer 31 at the uppermost stage and the flange portion 33b in the spacer 33 at the third stage from the top. The other set of connecting body 6 is arranged between the flange portion 33b and the flange portion 35b in the spacer 35 at the lowermost stage. Since these connecting bodies 6 have the substantially same configuration, in the following description, the connecting body 6 on the upper side will be exemplified and described unless otherwise specified.

As illustrated in FIGS. 2 to 4, the connecting body 6 is formed in an annular shape so as to be turnable around the axis of the rotating shaft 20. The connecting body 6 is configured by a plurality of roller current collectors 60 (in the present embodiment, eight roller current collectors on the upper stage side and eight roller current collectors on the lower stage side), a plurality of retainer pins 61 (in the present embodiment, eight retainer pins on the upper stage side and eight retainer pins on the lower stage side), and three guide plates 7A, 7B, 7C.

It is noted that in FIG. 3A, portions that overlap with the guide plate 7A in the axial direction among the roller current collectors 60 arranged immediately below the guide plate 7A are illustrated by broken lines. Regarding the roller current collectors 60 arranged immediately below the guide plate 7B, only portions expanded over the guide plates 7A, 7B in the radial direction are illustrated. Also, in FIG. 3B, portions that overlap with the guide plate 7B in the axial direction among the roller current collectors 60 arranged immediately below the guide plate 7B are illustrated partially by broken lines.

The roller current collector 60 is made of metal, formed in a cylindrical shape, and inserted and fixed onto center of a trunk portion in the retainer pin 61. A portion of the roller current collector 60, in other words, a radially inner side is arranged in the groove 40 in the inner peripheral electrode 4 (see FIG. 2). The roller current collector 60 is driven by rotation of the inner peripheral electrode 4 and spins on its own axis together with the retainer pin 61 about the axis of the retainer pin 61. Since upper and lower portions of the groove 40 expand to the radially outer side, the roller current collector 60 and the retainer pin 61 are regulated together from moving in the axial direction.

It is noted that the groove in which a portion of the roller current collector 60 is arranged is not limited to the groove 40 formed in the inner peripheral electrode 4, but may also be formed in the outer peripheral electrode 5, may be formed only in the outer peripheral electrode 5, or may be appropriately changed. Also, instead of the groove, annular step portions may be respectively provided in the inner peripheral electrode 4 and the outer peripheral electrode 5 so as to oppose each other in the axial direction, and by arranging and placing the roller current collector 60 between these annular step portions, the roller current collector 60 may be held in the axial direction.

An outer diameter of the roller current collector 60 is the substantially same size as a radial size between an outer circumferential surface of the inner peripheral electrode 4 and an inner circumferential surface of the outer peripheral electrode 5.

With reference to FIG. 4, the retainer pin 61 is made of an insulator. Respectively in an upper end and a lower end in the columnar trunk portion, columnar shaft portions 61a, 61b having a smaller diameter than this trunk portion are formed.

The shaft portion 61a is the upper end side (that is, the axially one side) and the shaft portion 61b is the lower end side (that is, the axially other side).

With reference to FIGS. 2 to 4, the guide plates 7A to 7C are annular thin plates made of an insulator. It is noted that any of the guide plates 7A to 7C has the same structure.

Therefore, the guide plate 7B will be exemplified and described unless otherwise specified.

The guide plate 7A is arranged on the upper end side, and serves as the other retainer plate of the present invention on the upper end side. The guide plate 7B is arranged between the guide plates 7A, 7C, that is, at the middle stage, and serves as a retainer plate of the present invention. The guide plate 7C is arranged on the lower end side, and serves as the other retainer plate of the present invention on the lower end side. With reference to FIG. 2, an axial size of the guide plate 7B is the substantially same size as an axial size of each of the spacers 22, 24, 32, 34. An inner diameter of the guide plate 7B is larger than an outer diameter of the spacers 21 to 25, and smaller than an inner diameter of each of the flange portions 31b, 33b, 35b.

Also, an outer diameter of the guide plate 7B is larger than the inner diameter of each of the flange portions 31b, 33b, 35b, and smaller than an inner diameter of each of the base portions 31a, 33a, 35a, and an inner diameter of each of the spacers 32, 34.

With reference to FIGS. 2 and 3, a width size in the guide plate 7B, that is, a radial size from an inner circumferential surface to an outer circumferential surface is shorter than a width size of the roller current collector 60.

With reference to FIG. 3, in the guide plate 7B, sixteen through holes 70 passing through in the axial direction are arranged at equal intervals on the same circumference. A diameter size of each of the through holes 70 is slightly longer than a diameter size of the shaft portions 61a, 61b in the retainer pin 61. Thereby, by inserting any of the shaft portions 61a, 61b in the retainer pins 61, the guide plates 7A to 7C can axially support the retainer pins 61 so that the retainer pins 61 are spinnable on their own axes.

In the connecting body 6 on the upper side, between the guide plates 7A, 7B, the eight retainer pins 61 onto which the roller current collectors 60 are respectively inserted are arranged at equal intervals. Also, between the guide plates 7B, 7C, the eight retainer pins 61 onto which the roller current collectors 60 are respectively inserted are arranged at equal intervals. That is, the guide plate 7B axially supports the retainer pins 61 respectively on the upper side serving as the axially one side and on the lower side serving as the axially other side.

In more detail regarding this, the shaft portions 61b in the eight retainer pins 61 arranged between the guide plates 7A, 7B are inserted into the through holes 70 in the guide plate 7B from the side of a surface 70f on the axially upper side in the guide plate 7B and axially supported. Also, these shaft portions 61b in the retainer pins 61 are inserted into every other sixteen through holes 70 arranged at equal intervals in the guide plate 7B.

Also, these shaft portions 61a in the retainer pins 61 are inserted into through holes 70 among sixteen through holes 70 arranged at equal intervals in the guide plate 7A, the through holes 70 being positioned on extension in the axial direction of the through holes 70 in the guide plate 7B into which the shaft portions 61b are inserted, from the side of a surface 70r on the axially lower side in the guide plate 7A, that is, the shaft portions 61a are inserted into every other through holes 70.

The shaft portions 61a in the retainer pins 61 arranged between the guide plates 7B, 7C are inserted into the through holes 70 in the guide plate 7B from the side of the surface 70r on the axially lower side in the guide plate 7B and axially supported. Also, these shaft portions 61a in the retainer pins 61 are inserted into the through holes 70 adjacent to the through holes 70 into which the shaft portions 61b in the retainer pins 61 arranged between the guide plates 7A, 7B are inserted.

Also, these shaft portions 61b in the retainer pins 61 are inserted into through holes 70 among sixteen through holes 70 arranged at equal intervals in the guide plate 7C, the through holes 70 being positioned on extension in the axial direction of the through holes 70 in the guide plate 7B into which the shaft portions 61a are inserted, from the side of a surface 70f on the axially upper side in the guide plate 7C, that is, the shaft portions 61b are inserted into every other through holes 70. In other words, the guide plate 7B axially supports the retainer pins 61 arranged on the axially lower side serving as the axially other side.

That is, the retainer pins 61 arranged between the guide plates 7A, 7B and the retainer pins 61 arranged between the guide plates 7B, 7C are arranged alternately in the circumferential direction in the guide plate 7B.

In other words, in the rotary connector 1, the retainer pins 61 on the upper stage side and the retainer pins 61 on the lower stage side that are arranged across the guide plate 7B at the middle stage are axially supported at different phases in the circumferential direction with respect to the guide plate 7B. Therefore, the retainer pins 61 at the respective stages are prevented from interfering with each other.

In the rotary connector 1 of the present embodiment configured as above, the four channels 9A, 9B, 9C, 9D are configured by the four inner peripheral electrodes 4, the four outer peripheral electrodes 5, and the two sets of connecting bodies 6.

In the channel 9A positioned at the uppermost stage, the inner peripheral electrode 4 and the outer peripheral electrode 5 at the uppermost stage are electrically connected and configured by the group of roller current collectors 60 on the upper stage side arranged between the guide plates 7A, 7B among the connecting body 6 on the upper side.

Also, in the channel 9B positioned at the second stage from the top, the inner peripheral electrode 4 and the outer peripheral electrode 5 at the second stage from the top are electrically connected and configured by the group of roller current collectors 60 on the lower stage side arranged between the guide plates 7B, 7C among the connecting body 6 on the upper side.

Also, in the channel 9C positioned at the second stage from the bottom, the inner peripheral electrode 4 and the outer peripheral electrode 5 at the second stage from the bottom are electrically connected and configured by the group of roller current collectors 60 on the upper stage side among the connecting body 6 on the lower side.

Also, in the channel 9D positioned at the lowermost stage, the inner peripheral electrode 4 and the outer peripheral electrode 5 at the lowermost stage are electrically connected and configured by the group of roller current collectors 60 on the lower stage side among the connecting body 6 on the lower side.

At the time of rotation of the inner peripheral electrodes 4, the roller current collectors 60 spin on their own axes in accordance with the rotation of the inner peripheral electrodes 4 together with the retainer pins 61 about the shaft portions 61a, 61b while in a state where the roller current collectors 60 are abutted with the outer circumferential surfaces in the inner peripheral electrodes 4 and the inner circumferential surfaces in the outer peripheral electrodes 5. It is noted that the roller current collectors 60 may be fitted to the retainer pins 61 with play and turn relatively to the retainer pins 61.

Also, the connecting body 6 spins on its own axis in accordance with rotation of the rotating body 2. Thereby, the roller current collectors 60 orbit about the rotating body 2. That is, the roller current collectors 60 do planetary motion.

Further, with the rotary connector 1, by arranging the roller current collectors 60 of the number corresponding to power distribution capacity required for the channels 9A to 9D, it is possible to appropriately adjust the power distribution capacity.

Regarding this, for example, upon connecting an electric load in which much power distribution capacity is required to the channel 9A at the uppermost stage and the channel 9B at the second stage from the top, by increasing the number of the roller current collectors 60 at the stages in the connecting body 6 on the upper side (to eight at maximum in the present embodiment), it is possible to increase the power distribution capacity.

Also, upon connecting an electric load in which required power distribution capacity is low to the channel 9C at the second stage from the bottom and the channel 9D at the lowermost stage, by reducing the number of the roller current collectors 60 (to one at minimum in the present embodiment), it is possible to reduce the power distribution capacity. Thereby, it is possible to apply the rotary connector 1 to transmission of electric signals, for example.

By these, with the rotary connector 1 of the present embodiment, even in a case of applying to a rotating device in which, for example, high speed rotation of the rotating shaft 20 or much power distribution capacity is required, and further, even in a case where required power distribution capacity is different between the channels, it is possible to continuously maintain electric connection between the inner peripheral electrodes 4 and the corresponding outer peripheral electrodes 5 without hindering rotation of the rotating device.

Further, with the rotary connector 1, in comparison to, for example, a configuration in which the retainer pins 61 at the respective stages are arranged concentrically, it is possible to shorten a thickness, that is, the axial size of the guide plate 7B while preventing the retainer pins 61 at the respective stages from interfering with each other. In accordance with this, it is also possible to shorten thicknesses of the corresponding spacers 22, 32 and the spacers 24, 34. Therefore, with the rotary connector 1, it is possible to shorten an axial size.

Regarding the point that the retainer pins 61 at the respective stages are prevented from interfering with each other, in more detail, for example, unlike the present embodiment, when retainer pins at respective stages are arranged concentrically, that is, in the same through hole, a lower end surface of a shaft portion in the retainer pin at the upper stage and an upper end surface of a shaft portion in the retainer pin at the lower stage are abutted and slide with each other.

Therefore, in the rotary connector 1 of the present embodiment, generation of friction by sliding of the retainer pins 61 at the respective stages with each other, generation of abrasion powder, drop-off of the retainer pins 61 from the guide plates 7A to 7C, etc., are prevented. That is, even in a case where the plurality of retainer pins 61 are used in the axial direction for a multi-channel structure, it is possible to stabilize motion of the retainer pins 61 and the roller current collectors 60 and a power distribution effect becomes stable.

Also, the retainer pins 61 at the respective stages are arranged at equal intervals in the connecting body 6. According to this, with the rotary connector 1, it is possible to prevent an adverse effect by uneven distribution of a centrifugal force, etc., generated in the retainer pins 61 at the respective stages of each set of connecting body 6. Therefore, with the rotary connector 1, it is possible to stably maintain a power distribution state.

Also, the sixteen through holes 70 are formed in the guide plate 7B. Therefore, the guide plate 7B can axially support the retainer pins 61 by inserting the shaft portions 61a or the shaft portions 61b in the retainer pins 61 at the respective stages into the different through holes 70. According to this, with the rotary connector 1, the number of the retainer pins 61 and the roller current collectors 60 is simply and conveniently adjusted in accordance with the required power distribution capacity.

Further, with the rotary connector 1, it is possible to accommodate part of the retainer pins 61 in the through holes 70 in comparison to, for example, a configuration in which retainers are axially supported by shaft portions extending from a retainer plate. Therefore, it is possible to shorten the axial size with a simple and convenient structure.

Also, the through holes 70 are formed on a single circumference. According to this, with the rotary connector 1 of the present embodiment, it is possible to reduce a radial size of the guide plate 7B in comparison to, for example, a configuration in which through holes are formed on a circumference on the radially inner side in a retainer plate and on a circumference on the radially outer side, that is, a configuration in which through holes are formed at positions different from each other in the radial direction. According to this, it is possible to configure the rotary connector 1 of the present embodiment to have a small diameter.

Further, regarding the through holes 70, in addition to the formation on a single circumference, the roller current collectors 60 and the retainer pins 61 of the substantially same shape are used. Thereby, it is possible to make outer diameters of the inner peripheral electrodes 4 arranged on the radially inner side with respect to the roller current collectors 60 which are axially supported by the guide plates 7A, 7B the substantially same size. That is, it is possible to manufacture only with the inner peripheral electrodes 4 of the same shape.

Meanwhile, for example, in the configuration in which the through holes are formed at positions different from each other in the radial direction in the retainer plate, in other words, the through holes are formed on the circumference on the radially inner side and on the circumference on the radially outer side, when retainer pins arranged on the upper stage side are axially supported by the through holes on the radially inner side and retainer pins arranged on the lower stage side are axially supported by the through holes on the radially outer side, as inner peripheral electrodes on the upper stage side, there is a need to apply inner peripheral electrodes having a smaller diameter than inner peripheral electrodes on the lower stage side.

In such a way, it is possible to configure the rotary connector 1 of the present embodiment by applying the plurality of inner peripheral electrodes 4 of the same shape. Thus, it is possible to reduce manufacturing cost and assembling cost. The same applies to the outer peripheral electrodes 5.

Also, with the rotary connector 1, one set of connecting body 6 is configured by a double layer structure configured by the two groups of retainer pins 61 at adjacent stages, the guide plate 7B in the middle, and the two other guide plates 7A, 7C.

Therefore, the connecting body 6 has a simple structure, high mechanical strength, and small size tolerance. Thereby, for example, inclination of the connecting body 6 which becomes remarkable more easily as the number of stages of a single connecting body 6 is increased by tolerance of the members, eccentricity with respect to the rotating shaft 20, drop-off of the retainer pins 61 from the guide plate 7B, etc., are more easily suppressed.

Further, with the rotary connector 1, by making one set of connecting body 6 with the double layer structure, it is possible to reduce weight more than one set of connecting body made with a three-layer or more-layer structure. Thereby, a load applied to the guide plate 7C on the lower end side is reduced. Thus, abrasion by sliding contact with the flange portion 33b in the spacer 33 in center in the axial direction is suppressed.

Also, in the rotary connector 1, the retainer pins 61 on the upper stage side and the retainer pins 61 on the lower stage side are arranged across the guide plate 7B. Thereby, upon spinning of the connecting body 6, it is possible to make speed of orbit of the retainer pins 61 on the upper stage side and speed of orbit of the retainer pins 61 on the lower stage side the same speed.

Therefore, with the rotary connector 1 of the present embodiment, it is possible to stabilize a power distribution effect in comparison to a configuration in which a guide plate by which the shaft portions 61b in the retainer pins 61 on the upper stage side are axially supported is disposed on a guide plate by which the shaft portions 61a in the retainer pins 61 on the lower stage side are axially supported so as to be movable relatively.

In particular, with the configuration in which the inner peripheral electrodes 4 for the two channels 9A and 9B and the corresponding outer peripheral electrodes 5 are electrically connected by one set of connecting body 6 as in the present embodiment, it is possible to use differently for the positive electrode side and for the negative electrode side, and respective power distribution states of the positive electrode side and the negative electrode side are stabilized. That is, with the rotary connector 1 of the present embodiment, it is possible to easily design and manufacture a double channel configuration that is applied to many uses in power wires, electric signal wires, etc.

Further, in the rotary connector 1, in the connecting body 6 on the upper side and the connecting body 6 on the lower side, due to a difference in the number of the roller current collectors 60, there may be a case where a difference in friction generated following rotation is generated. Even in such a case, with the rotary connector 1 of the present embodiment, interference between the connecting body 6 on the upper side and the connecting body 6 on the lower side is prevented.

Therefore, with the rotary connector 1, even when the number of the roller current collectors 60 arranged for each connecting body 6 is different, it is possible to continuously maintain electric connection between the inner peripheral electrodes 4 and the corresponding outer peripheral electrodes 5 while maintaining turning of the rotating shaft 20.

Also, in the rotary connector 1, the spacers 21 to 25 in the rotating body 2 and the spacers 31 to 35 in the stationary body 3 are separate bodies from each other. Not only axial positions of the inner peripheral electrodes 4 and the corresponding outer peripheral electrodes 5 are maintained, but also upon rotating the rotating body 2, contact between the spacers 21 to 25 and the spacers 31 to 35 and contact between the inner peripheral electrodes 4 and the spacers 31 to 35 are prevented.

Also, in the connecting body 6 on the upper side, the guide plate 7C on the lower end side is disposed on the flange portion 33b in the spacer 33 in center in the axial direction. Thereby, in the rotary connector 1, it is possible to reliably support one set of connecting body 6 and stabilize the power distribution effect.

Also, in the rotary connector 1, a speed difference between spinning speed of the connecting body 6 and the stationary body 3 that is static is smaller than a speed difference between rotation speed of the rotating shaft 20 and the spinning speed of the connecting body 6. From this, with the rotary connector 1 of the present embodiment, in comparison to a configuration in which the connecting body 6 is disposed and supported on a flange portion provided on the side of the rotating body 2 that is rotated integrally with the rotating shaft 20, the abrasion powder due to the sliding contact between the guide plate 7C and the flange portion 33b is less easily generated.

Also, in the rotary connector 1, there may be a case where the abrasion powder is generated due to sliding contact between the roller current collectors 60 and the inner peripheral electrodes 4, for example. Even in such a case, it is possible to trap the abrasion powder by the flange portion 33b in the spacer 33 and the flange portion 35b in the spacer 35.

It is noted that the flange portions 31b, 33b, 35b are formed in an annular shape that continues over the circumferential direction in the present embodiment. However, the present invention is not limited to this but may have a configuration in which one or more non-continuous extension pieces are arranged in the circumferential direction.

Also, in the connecting body 6 on the upper side, the guide plate 7A on the upper end side is arranged on the lower side of the flange portion 31b in the spacer 31 at the uppermost stage. Therefore, with the rotary connector 1, it is possible to regulate the three guide plates 7A, 7B, 7C, the roller current collectors 60, and the retainer pins 61 which are stacked from respectively individually inclining and moving in the axial direction, maintain the electric connection between the corresponding inner peripheral electrodes 4 and the outer peripheral electrodes 5, and also suppress generation of breakdown.

In more detail, the flange portion 31b is positioned on the slightly upper side of the guide plate 7A in the connecting body 6 in a state where the guide plate 7C in the connecting body 6 is disposed on the flange portion 33b.

Therefore, in the rotary connector 1 of the present embodiment, upon the spinning of the connecting body 6 on its own axis about the rotating shaft 20, in comparison to a configuration in which the connecting body 6 is always in contact with the flange portions 31b, 33b, friction to be possibly generated is reduced. It is noted that the present invention may have a configuration in which the connecting body 6 is always in contact with the flange portions 31b, 33b. With such a configuration, it is preferable that the guide plates 7A, 7C and the flange portions 31b, 33b are made of a low friction member, and a lubricating material is placed in-between.

Also, a separation size in the axial direction between the flange portion 31b and the guide plate 7A in the connecting body 6 is shorter than an axial size required for taking one of the shaft portions 61a, 61b in any of the retainer pins 61 out from the through hole 70 into which the shaft portion is inserted. Thereby, in the rotary connector 1, even in a case where the connecting body 6 moves in the axial direction, it is possible to continuously maintain a three-dimensional structure of the connecting body 6.

In other words, with the rotary connector 1 of the present embodiment, there is no need to provide a support post, etc., for coupling the guide plates 7A, 7B, for example. Thus, it is possible to simply and conveniently configure the connecting body 6.

It is noted that the present invention may have a structure in which the retainer pins 61 are engaged so as not to be turnable relatively to the guide plates 7A, 7B, that is, the guide plates 7A, 7B may be coupled in a stationary manner by the retainer pins 61, or a configuration in which the retainer pins 61 formed integrally with the retainer plate on one side may be fitted and fixed into the through holes 70 or recess portions of the retainer plate on the other side, and the guide plates 7A, 7B may be coupled by support posts, etc., other than the retainer pins 61. With such a configuration, it is possible to more reliably maintain the three-dimensional structure of the connecting body 6.

In this case, it is preferable that the roller current collectors 60 are axially supported so as to be turnable relatively to the retainer pins 61.

Also, a shape of the retainer pins 61 may be, for example, a columnar shape, a square pillar shape, or a bobbin shape in which flanges are provided in both axial ends of a columnar trunk portion, or may be appropriately changed. The same applies to the shaft portions.

Also, the present invention may have a configuration in which the roller current collectors 60 are inserted onto the retainer pins 61 so as to be turnable relatively to the retainer pins 61, and in this case, may have a configuration in which the roller current collectors 60 are elastically deformed in the radial direction. With such a configuration, it is possible to prevent an excessive load from acting on the inner peripheral electrodes 4 and the outer peripheral electrodes 5.

Also, in the connecting body 6 of the present embodiment, the guide plates 7A to 7C have the same shape, and types of the members are reduced. Thus, an assembling error does not occur and it is possible to reduce member cost and manufacturing cost.

It is noted that the shapes of the guide plates 7A to 7C may be different from each other. For example, the number of the through holes 70 formed in the guide plates 7A, 7C may be lower than the number of the through holes 70 formed in the guide plate 7B.

Also, as described above, the width size in the guide plates 7A to 7C is shorter than the outer diameter of the roller current collectors 60. In addition, outer circumferential surfaces in the spacers 21 to 25 on the rotating body 2 side are substantially flush with each other. Further, inner circumferential surfaces in the spacers 32, 34 on the stationary body 3 side, inner circumferential surfaces in the base portions 31a, 33a, 35a, and the inner circumferential surfaces in the outer peripheral electrodes 5 are substantially flush with each other.

By these, in a state where the roller current collectors 60 are abutted with the corresponding inner peripheral electrodes 4 and the outer peripheral electrodes 5, it is possible to continuously hold the guide plates 7A to 7C at positions separated in the radial direction from the outer circumferential surfaces in the spacers 21 to 25, the inner circumferential surfaces in the spacers 32, 34, and the inner circumferential surfaces in the base portions 31a, 33a, 35a. Thereby, in the rotary connector 1, it is possible to reduce friction to be possibly generated upon the spinning of the connecting body 6.

Also, the outer diameter of the roller current collectors 60 is larger than the maximum outer diameter of the retainer pins 61, that is, the outer diameter of the trunk portions in the retainer pins 61.

Thereby, upon spinning, the roller current collectors 60 prevent the retainer pins 61 from being in contact with the inner peripheral electrodes 4 and the outer peripheral electrodes 5. Therefore, in the rotary connector 1, it is possible to reduce the friction to be possibly generated upon the spinning of the roller current collectors 60.

### Second Embodiment

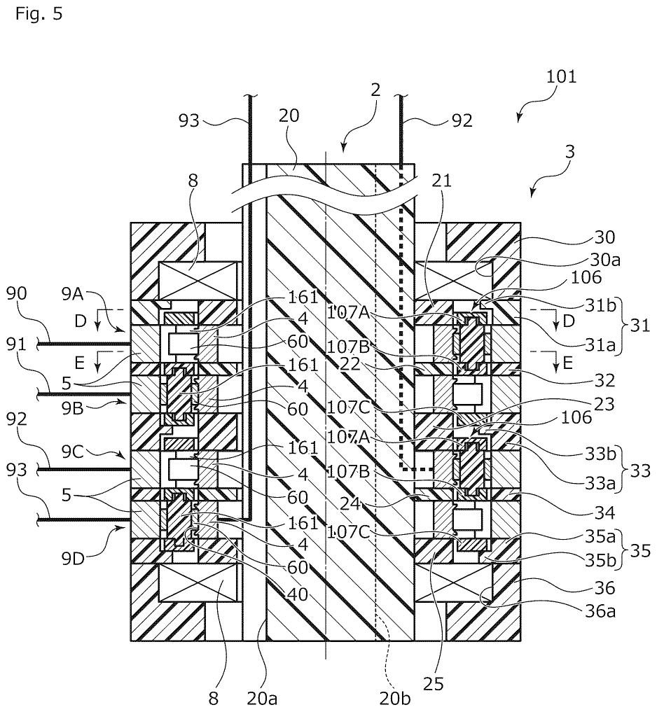

Next, a rotary connector according to a second embodiment of the present invention will be described with reference to FIGS. 5 to 7. It is noted that the same configuration portions as the configuration portions shown in the first embodiment will be given the same reference signs and a duplicated description will be omitted.

As illustrated in FIG. 5, a rotary connector 101 according to the second embodiment is configured by a rotating body 2, a stationary body 3, and two sets of connecting bodies 106. The connecting body 106 is mainly configured by a plurality of roller current collectors 60, a plurality of retainer pins 161, and guide plates 107A to 107C.

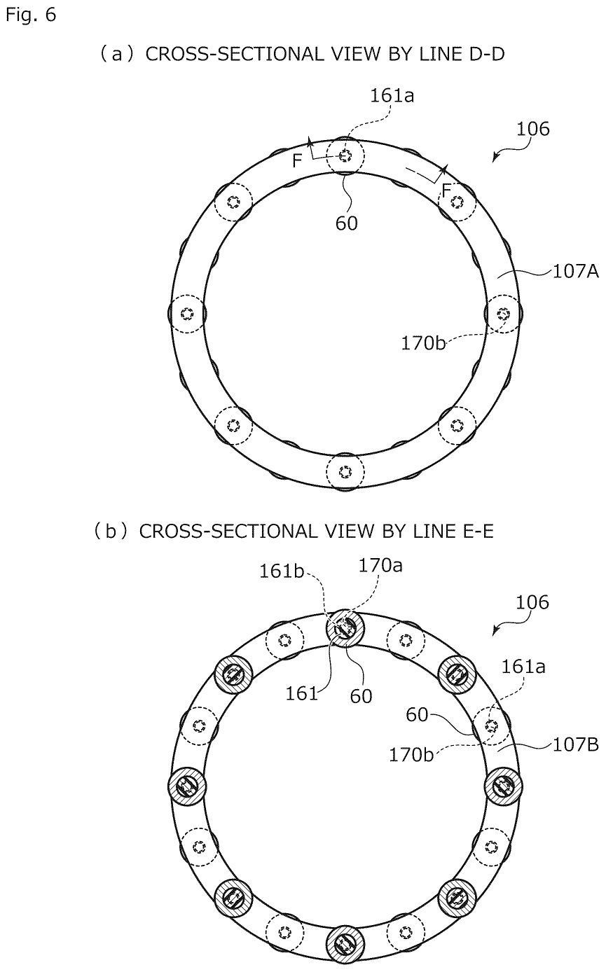

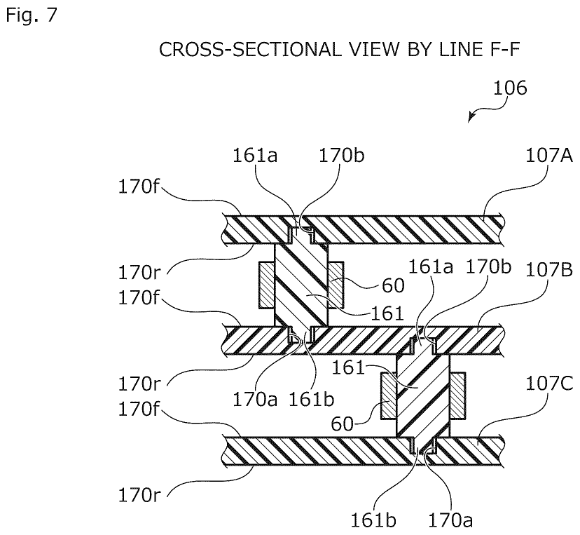

With reference to FIGS. 6 and 7, in the guide plate 107B, eight upward opening recess portions 170a provided to be recessed downward from a surface 170f on the axially upper side and open upward are arranged at equal intervals. Also, in the guide plate 107B, eight downward opening recess portions 170b provided to be recessed upward from a surface 170r on the axially lower side and open downward are arranged at equal intervals. These recess portions 170a, 170b are arranged alternately in the circumferential direction.

From this, with the guide plate 107B of the present embodiment, it is possible to form a thin guide plate in comparison to a configuration in which one upward opening recess portion 170a and one downward opening recess portion 170b are formed on the same axis.

In the guide plate 107A, only eight downward opening recess portions 170b arranged at equal intervals are formed. In the guide plate 107C, only eight upward opening recess portions 170a arranged at equal intervals are formed.

It is noted that in FIG. 6A, the downward opening recess portions 170b in the guide plate 107A are illustrated by broken lines, and in FIG. 6B, the recess portions 170a, 170b in the guide plate 107B are illustrated by broken lines.

According to this, by fitting shaft portions 161a on the upper end side (in other words, the axially one side) of the retainer pins 161 to the downward opening recess portions 170b in the guide plate 107A with play so as to be relatively turnable, and fitting shaft portions 161b on the lower end side (in other words, the axially other side) of the same retainer pins 161 to the upward opening recess portions 170a in the guide plate 107B with play, the guide plates 107A, 107B can axially support the retainer pins 161.

Also, by fitting the shaft portions 161a on the upper end side of the retainer pins 161 to the downward opening recess portions 170b in the guide plate 107B with play so as to be relatively turnable, and fitting the shaft portions 161b on the lower end side of the same retainer pins 161 to the upward opening recess portions 170a in the guide plate 107C with play, the guide plates 107B, 107C can axially support the retainer pins 161.

Further, it is possible to arrange the retainer pins 161 arranged between the guide plates 107A and 107B and the retainer pins 161 arranged between the guide plates 107B and 107C at different positions with respect to the guide plate 107B.

In such a way, it is possible to provide the rotary connector 101 in which the number of the retainer pins 161 and the roller current collectors 60 is simply and conveniently adjusted in accordance with required power distribution capacity even with the configuration in which the eight upward opening recess portions 170a and the eight downward opening recess portions 170b are formed in the guide plate 107B.

Also, in the guide plate 107B, it is possible to accommodate part of the retainer pins 161 in the recess portions 170a or 170b. Therefore, it is possible to shorten an axial size with a simple and convenient structure.

Also, the eight upward opening recess portions 170a and the eight downward opening recess portions 170b are respectively formed on a single circumference. Therefore, it is also possible to configure the rotary connector 101 of the second embodiment to have a small diameter.

Also, since the surface 170r on the axially lower side in the guide plate 107C is a flat surface, it is possible to more smoothly bring into sliding contact with the flange portion 33b (see FIG. 2).

Similarly, since the surface 170f on the axially upper side in the guide plate 107A is a flat surface, it is possible to more smoothly bring into sliding contact with the flange portion 31b (see FIG. 2).

It is noted that the guide plates 107A, 107C may be members of the same shape as the guide plate 107B. With such a configuration, types of the members are reduced. Thus, an assembling error does not occur and it is possible to reduce member cost and manufacturing cost.

### Third Embodiment

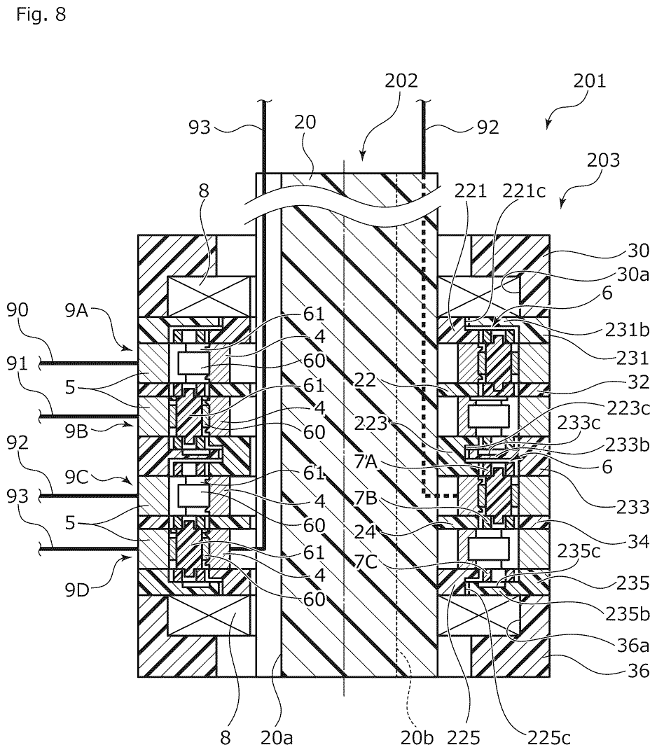

Next, a rotary connector according to a third embodiment of the present invention will be described with reference to FIG. 8. It is noted that the same configuration portions as the configuration portions shown in the first embodiment will be given the same reference signs and a duplicated description will be omitted.

In a rotary connector 201 according to the third embodiment, flange portions 231b, 233b, 235b are formed in spacers 231, 233, 235 in a stationary body 203.

In spacers 221, 223, 225 in a rotating body 202, annular grooves 221c, 223c, 225c provided to be recessed in the radially inner direction from outer circumferential surfaces and open in the radially outer direction are formed.

A radially inner side end portion in the flange portion 231b is arranged in the annular groove 221c. A radially inner side end portion in the flange portion 233b is arranged in the annular groove 223c. A radially inner side end portion in the flange portion 235b is arranged in the annular groove 225c.

Thereby, even when abrasion powder is generated due to sliding contact with inner peripheral electrodes 4 and outer peripheral electrodes 5, it is possible to regulate falling abrasion powder or flying abrasion powder from moving to the axially outer side of the flange portions 231b, 233b by the flange portions 231b, 233b that sandwich one set of connecting body 6 in the axial direction. The same applies to the flange portions 233b, 235b and one set of connecting body 6 arranged between the flange portions 233b, 235b.

Also, a gap having an L-shaped section is defined by the flange portion 231b and the annular groove 221c and a labyrinth structure is configured. Thereby, in order to move to the axially outer side of the flange portion 231b, the abrasion powder is required to move to the radially inner side and further move in the axial direction. Thus, it is possible to more reliably trap the abrasion powder. The same applies to a gap between the flange portion 233b and the annular groove 223c, and a gap between the flange portion 235b and the annular groove 225c.

Further, in the flange portions 233b, 235b, annular recess portions 233c, 235c provided to be recessed to the axially lower side from center in the radial direction in an upper end surface and open toward the axially upper side are formed. Thereby, it is possible to store the abrasion powder at a position where sliding contact between the flange portion 233b and the guide plate 7C in the connecting body 6 is not hindered. The same applies to the flange portion 235b.

The first to third embodiments of the present invention are described above based on the drawings. However, specific configurations are not limited to these first to third embodiments and the present invention includes changes and additions within a range not departing from the scope of the present invention.

For example, in the first to third embodiments described above, the rotary connector is described with the configuration to be applied to a semiconductor manufacturing machine serving as a rotating device. However, the present invention is not limited to this but the rotary connector may be applied to a monitoring camera, and a rotating device to which the rotary connector is applied may be appropriately changed.

Also, in the first to third embodiments described above, the configuration in which the rotating body is arranged on the radially inner side of the stationary body is described. However, the present invention is not limited to this but may have a configuration in which a stationary body is arranged on the radially inner side of a rotating body. That is, inner peripheral electrodes are electrodes on the stationary body side, and outer peripheral electrodes may be electrodes on the rotating body side.

Also, in the first to third embodiments described above, the configuration in which the sixteen through holes or recess portions are formed in the retainer plate is described. However, the present invention is not limited to this but including the retainer pins configured integrally with the retainer plate, the number and arrangement may be appropriately changed.

Also, in the first to third embodiments described above, the configuration in which the number of the retainer pins arranged at the respective stages is adjusted upon adjusting the power distribution capacity is described. However, the present invention is not limited to this but while the number of the retainer pins is fixed, the number of the roller current collectors inserted onto the retainer pins may be changed.

Also, in the first to third embodiments described above, the configuration in which the same number of the roller current collectors and the same number of the retainer pins are arranged at equal intervals at the respective stages is described. However, the present invention is not limited to this but as long as positions with respect to the retainer plate are different, the number and arrangement may be appropriately changed. The same applies to the through holes, the recess portions, etc., of the retainer plate for axially supporting the retainer pins.

This arrangement in which the positions are different will be described in more detail. The present invention may not have the configuration in which phases in the circumferential direction are displaced as described in the first embodiment, for example, that is, the configuration in which the retainer pins are arranged to be separated in the circumferential direction.

For example, the present invention may have a configuration in which positions in the radial direction are displaced, for example, that is, a configuration in which the retainer pins are arranged to be separated in the radial direction, and the retainer pins arranged on the same circumference on the radially inner side seen from the axial direction and the retainer pins arranged on the same circumference on the radially outer side overlap with each other when seen from the radial direction.

Further, the present invention may have a configuration in which positions in the radial direction and in the circumferential direction are displaced, that is, a configuration in which the retainer pins are arranged to be separated in the radial direction and in the circumferential direction, and the retainer pins arranged on the same circumference on the radially inner side seen from the axial direction and the retainer pins arranged on the same circumference on the radially outer side do not overlap with each other when seen from the radial direction.

With such configurations, it is possible to increase the number of the roller current collectors that are capable of being arranged at the respective stages in comparison to the configuration in which the retainer pins are arranged on a single circumference as in the rotary connector in the first to third embodiments.

Also, in the first to third embodiments described above, the configuration in which one set of the connecting body is made with the double layer structure including the two groups of retainer pins at adjacent stages is described. However, the present invention is not limited to this but one set may be made with a three-layer or more-layer structure. With such a configuration, it is possible to reduce the number of extension portions for disposing one set of connecting body.

Thus, it is possible to further shorten the axial size of the rotary connector.

Also, in the first to third embodiments described above, the configuration in which the rotary connector is arranged and placed vertically with the axis being along the perpendicular direction is described. However, the present invention is not limited to this but the rotary connector may be arranged and placed horizontally with the axis being along the horizontal direction. Even with such a configuration, by providing extension portions respectively on both the axial end sides of the connecting body, it is possible to continuously hold positions in the axial direction with respect to the inner peripheral electrodes and the corresponding outer peripheral electrodes.

Also, in the first to third embodiments described above, the configuration in which the extension portion on the upper end side and the extension portion on the lower end side are provided in the spacers on the stationary body side is described. However, the present invention is not limited to this but the extension portions may be provided in the spacers on the rotating body side, or may be provided in members other than the spacers irrespective of the rotating body side and the stationary body side.

### REFERENCE SIGNS LIST

1 Rotary connector
2 Rotating body
3 Stationary body
4 Inner peripheral electrode
5 Outer peripheral electrode
6 Connecting body
7A Guide plate (other retainer plate)
7B Guide plate (retainer plate)
7C Guide plate (other retainer plate)
8 Bearing
9A to 9D Channel
31b Flange portion (extension portion on upper end side)
33b Flange portion (extension portion on lower end side, extension portion on upper end side)
35b Flange portion (extension portion on lower end side)
60 Roller current collector
61 Retainer pin
70 Through hole
70f Surface on axially upper side (surface on axially one side)
70r Surface on axially lower side (surface on axially other side)
101 Rotary connector
106 Connecting body
107A Guide plate (other retainer plate)
107B Guide plate (retainer plate)
107C Guide plate (other retainer plate)
161 Retainer pin
170a Upward opening recess portion
170b Downward opening recess portion
170f Surface on axially upper side (surface on axially one side)
170r Surface on axially lower side (surface on axially other side)
201 Rotary connector
231b Flange portion (extension portion on upper end side)
233b Flange portion (extension portion on lower end side, extension portion on upper end side)
235b Flange portion (extension portion on lower end side)

1. A rotary connector, comprising:
an annular outer peripheral electrode;
an inner peripheral electrode inserted into the outer peripheral electrode and arranged so as to be turnable relatively to the outer peripheral electrode;
annular roller current collectors arranged between the outer peripheral electrode and the inner peripheral electrode, the roller current collectors being in contact with the outer peripheral electrode and the inner peripheral electrode;
retainer pins inserted into the roller current collectors and holding the roller current collectors; and
a retainer plate that axially supports the retainer pins,
wherein the retainer pins are respectively axially supported on an axially one side and on an axially other side of the retainer plate, and
wherein the retainer pin axially supported on the axially one side and the retainer pin axially supported on the axially other side are arranged in different phases.

2. The rotary connector according to claim 1,
wherein the retainer pins are arranged at equal intervals in the circumferential direction.

3. The rotary connector according to claim 1,
wherein a plurality of through holes are formed in the retainer plate.

4. The rotary connector according to claim 3,
wherein the plurality of through holes are formed on a single circumference.

5. The rotary connector according to claim 1,
wherein in the retainer plate, a plurality of recess portions are respectively formed on a surface on the axially one side and on a surface on the axially other side.

6. The rotary connector according to claim 5,
wherein the plurality of recess portions are formed on a single circumference.

7. The rotary connector according to claim 1,
wherein the retainer pin axially supported on the axially one side and the retainer pin axially supported on the axially other side are also axially supported by other retainer plates respectively arranged on the axially opposite sides of the retainer plate.

8. The rotary connector according to claim 1,
wherein the rotary connector is vertically placed,
wherein a lower end side of the retainer pin axially supported on the axially other side is axially supported by a retainer plate on the lower end side, the retainer plate being other than the retainer plate, and
wherein the retainer plate on the lower end side is disposed on an extension portion on the lower end side, the extension portion extending from one side of an outer peripheral electrode side and an inner peripheral electrode side to other side.

9. The rotary connector according to claim 8,
wherein an upper end side of the retainer pin axially supported on the one side is axially supported by a retainer plate on the upper end side, the retainer plate being other than the retainer plate, and
wherein the retainer plate on the upper end side is arranged on the lower side of an extension portion on the upper end side, the extension portion extending from one side of the outer peripheral electrode side and the inner peripheral electrode side to other side.
